(19) United States
(12) Patent Application Publication
(10) Pub. No.: US 2024/0217443 A1
(43) Pub. Date: Jul. 4, 2024

(54) VEHICLE CENTER CONSOLE PASS THROUGH SYSTEM

(71) Applicant: FCA US LLC, Auburn Hills, MI (US)

(72) Inventors: Benjamin T. Treinen, Birmingham, MI (US); Everard J. Scott, Sterling Heights, MI (US); Ryan C. Nagode, West Bloomfield, MI (US); Brandon F. Brady, Lapeer, MI (US); Jon P. Gaudreau, Rochester Hills, MI (US)

(21) Appl. No.: 18/544,497

(22) Filed: Dec. 19, 2023

Related U.S. Application Data
(60) Provisional application No. 63/478,374, filed on Jan. 4, 2023.

(51) Int. Cl. B60R 7/04; B60N 2/75; B60N 3/10; B60R 11/00; B62D 25/08; B62D 25/20

(52) U.S. Cl. CPC B60R 7/04; B60N 2/773; B60N 3/102; B62D 25/087; B62D 25/20; B60R 2011/008

(57) ABSTRACT

A vehicle includes a body at least partially defining a vehicle cabin, and a center console disposed within the vehicle cabin and including a center console pass-through configured to enable cargo to extend therethrough for storage of the cargo. The center console includes a lower storage portion coupled to a floor of the vehicle, and an upper storage portion connected to and spaced apart from the lower storage portion to define the center console pass-through between the lower storage portion and the upper storage portion.

### CROSS REFERENCE TO RELATED APPLICATION

This application claims the benefit of U.S. Provisional Pat. App. No. 63/478,374, filed Jan. 4, 2023, the contents of which are incorporated herein by reference thereto.

### FIELD

The present application relates generally to vehicle systems and, more particularly, to a vehicle with a cargo pass through system.

### BACKGROUND

Battery electric vehicles (BEVs) often do not require structural features needed by conventional internal combustion engine vehicles, such as a transmission tunnel, thereby allowing for a flat floor to provide more design flexibility for interior components. Such BEVs typically include a center console disposed between the driver and front passenger seats. However, these conventional automotive center consoles often lack flexibility and functionality, particularly when large/long storage solutions are desired. Thus, while conventional systems work for their intended purpose, it is desirable to provide continuous improvement in the relevant art to provide greater utility.

### SUMMARY

In accordance with one example aspect of the invention, a vehicle is provided. In one example implementation, the vehicle includes a body at least partially defining a vehicle cabin, and a center console disposed within the vehicle cabin and including a center console pass-through configured to enable cargo to extend therethrough for storage of the cargo.

In addition to the foregoing, the described vehicle may include one or more of the following features: wherein the center console includes a lower storage portion coupled to a floor of the vehicle, and an upper storage portion connected to and spaced apart from the lower storage portion to define the center console pass-through between the lower storage portion and the upper storage portion; wherein the vehicle further includes a track system integrated into the vehicle floor, wherein the lower storage portion is removably and slidably coupled to the track system; and wherein the upper storage portion includes at least one expandable storage tray configured to move between a retracted position that does not obstruct the center console pass-through when cargo extends through the center console pass-through, and an extended position that increases a storage capacity of the expandable storage tray when the center console pass-through is not being utilized.

In addition to the foregoing, the described vehicle may include one or more of the following features: wherein the upper storage portion further includes a pair of slidable armrests, one or more slidable cup holders, and an integrated wireless charger; a rear cargo area and a foldable midgate separating the rear cargo area and the vehicle cabin, wherein the foldable midgate is configured to fold substantially flat to enable cargo to extend from the rear cargo area, into the vehicle cabin, and through the center console pass-through; and wherein the foldable midgate includes a retractable window configured to be selectively retracted into a main body of the foldable midgate for protection thereof.

In addition to the foregoing, the described vehicle may include one or more of the following features: wherein the foldable midgate is configured to rotate forward into the vehicle cabin to a stowed position that is substantially planar with a floor of the rear cargo area; wherein the rear cargo area is pickup truck storage bed having a floor, a pair of side walls, and a tailgate; a frunk, a firewall separating the frunk and the vehicle cabin, a passage extending through the firewall, and a door configured to move between a closed position that blocks the passage, and an open position that enables cargo to pass through the passage; and wherein the door is retractable within the firewall.

In addition to the foregoing, the described vehicle may include one or more of the following features: a rear cargo area, and a foldable midgate separating the rear cargo area and the vehicle cabin, wherein the foldable midgate is configured to fold substantially flat to enable cargo to extend from the rear cargo area, into the vehicle cabin, through the center console pass-through, through the firewall passage, and into the frunk; wherein the cargo passes through the center console pass-through at a distance elevated from a floor of the vehicle cabin; wherein a floor of the rear cargo area is at a higher elevation than the floor of the vehicle cabin; wherein the center console interrupts a path along a floor of the vehicle cabin between the rear cargo area and the firewall passage;

wherein the vehicle is a battery electric vehicle.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a side sectional view of a vehicle with an example cargo pass-through system in accordance with the principles of the present application;

FIG. 2 is a perspective view of the cargo pass-through system of FIG. 1, in accordance with the principles of the present application; and

FIG. 3 is a partial cutaway perspective view of an example center console of the cargo pass-through system of FIG. 1, in accordance with the principles of the present application.

### DESCRIPTION

As previously mentioned, conventional vehicles often lack flexibility and functionality with typical automotive center consoles. Moreover, it is desirable to maximize space in a vehicle interior to handle large/long cargo loads. Accordingly, the systems described herein provide a flexible vehicle interior capable of handling large/long cargo without sacrificing the amenities of a center console.

In one example, a vehicle cargo pass-through system includes a plurality of components configured to provide storage flexibility, including a dropping glass and folding midgate, a center console pass-through, a center console dropping bin, a firewall pass-through into a frunk (front trunk), a lower console storage, and a floor track system. The center console includes a center pass-through at the height of the frunk and cargo bed. The allows long items (e.g., lumber) to be slid from the cargo bed, past the folded midgate, through the center console, and past the firewall into the frunk.

The center pass-through is positioned below an upper bin that expands into the pass-through aperture to maximize storage in the center console when the center pass-through is not in use. A lower portion of the center console includes a storage volume for larger items below the pass-through, enabling maximum flexibility to store different items in the center console. Additionally, the midgate and firewall door work in conjunction with the center console. The rear glass automatically drops into the midgate, allowing it to fold flat with the cargo bed, and the firewall door retracts, allowing long items (e.g., 18 feet) to pass from the cargo bed into the frunk, or vice versa.

In order to provide maximum flexibility and avoid compromising internal storage, the center console upper bin in front of the armrest expands to increase its volume when the console pass-through is not being utilized. Further, the center console is removably coupled to a track system in the vehicle floor, allowing the center console to slide forward under the instrument panel, rearward to the second row, or removed entirely to provide maximum flat floor space. The interaction between the firewall door and the midgate offers further flexibility when storing items, allowing a user to shorten or expand the pass-through length by selectively opening/closing the midgate and/or the firewall. Further, the system provides a fully enclosed pass-through when only the firewall is opened.

Advantageously, the user does not sacrifice the amenities of the center console, as long cargo is passed through the lower portion of the center console, still leaving storage, cupholders, work surfaces, wireless charging, etc. available to the user.

As such, the systems described herein allow long cargo to be passed through the entire cabin while maintaining a feature-rich center console. The system provides full cargo pass-through functionality and then can transform the front storage bin to drop and provide maximum storage space in the center console.

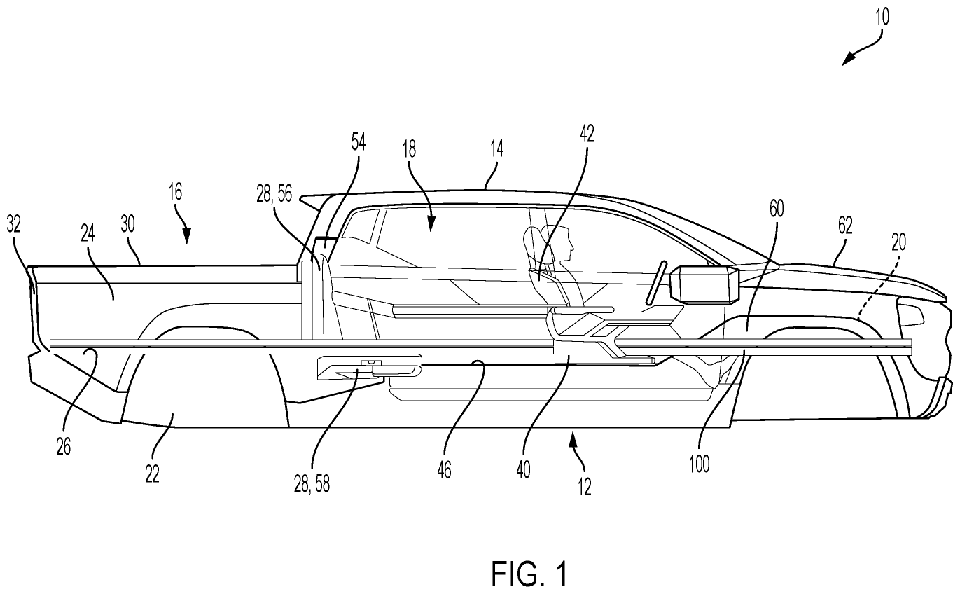

With reference now to FIG. 1, a vehicle 10 with an example cargo pass-through system 12 is illustrated in accordance with the principles of the present invention. In the example embodiment, the vehicle 10 generally includes a body 14 defining a storage bed 16, a vehicle cabin 18, and a front storage area or frunk 20. In the example embodiment, the vehicle 10 is a pickup truck having storage bed 16 located above one or more rear wheels 22. In alternative arrangements, vehicle 10 maybe a vehicle having a cargo area above the rear wheels 22 and a closure member, such as a sport utility vehicle with a rear cargo area and a rear hatch. The storage bed 16 provides a rear cargo area 24 at least partially defined by a floor 26, a foldable midgate 28, side walls 30, and a tailgate 32.

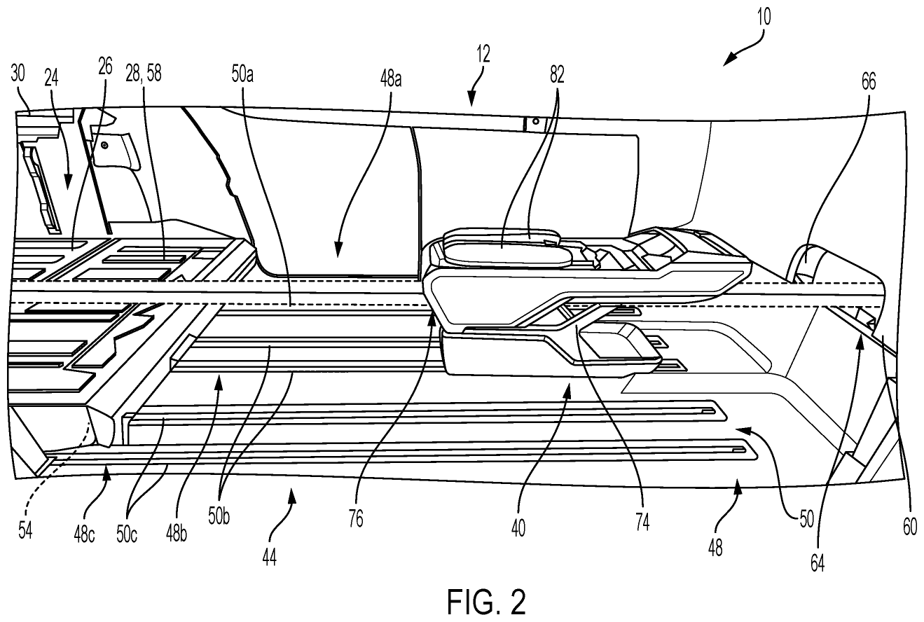

With additional reference to FIG. 2, in the example embodiment, the vehicle cabin 18 includes a center console 40 and a plurality of vehicle seats 42 slidably and removably coupled to a track system 44 that is integrated with a floor 46 of the vehicle 10. In this way, the center console 40 and each vehicle seat 42 maybe removably coupled to the track system 44 such that the center console 40 and a desired number of seats 42 maybe removed from or installed into the vehicle 10. This gives a user the ability to vary the seating arrangements within vehicle 10 to provide a desired amount of cargo space or to accommodate a desired number of passengers.

In the example implementation shown in FIG. 2, the track system 44 includes three track assemblies 48 each having a pair of tracks 50 extending fore-aft in the vehicle cabin 18. More specifically, the track system 44 includes a driver side track assembly 48a with tracks 50a a middle track assembly 48b with tracks 50b and a passenger side track assembly 48c with tracks 50c. Each track assembly 48 is configured to removably receive the center console 40 and one or more vehicle seats 42. The center console 40 and vehicle seats 42 are configured to selectively slide along the track assemblies 48 and lock into a desired position within the vehicle cabin 18. However, in the example embodiment with cargo pass-through system 12, the center console 40 is coupled to the middle track assembly 48b, and vehicle seats 42 are coupled to outboard track assemblies 48a, 48c.

With continued reference to FIGS. 1 and 2, the foldable midgate 28 is located between and separates the storage bed 16 and the vehicle cabin 18. In the example embodiment, the foldable midgate 28 includes a main body 52 and a retractable window 54. The main body 52 extends generally cross-vehicle between the sides of the vehicle body 14 and/or storage bed sidewalls 30. The main body 52 is rotatably coupled to the vehicle body 14 and is configured to move between an upright position 56 and a folded or stowed position 58.

In the upright position 56, the main body 52 separates the storage bed 16 and the vehicle cabin 18. The midgate 28 is configured to rotate forward into the vehicle cabin 18 into the stowed position 58 where it is planar with or substantially planar with the storage bed floor 26. In the upright position 56, the retractable window 54 is deployed to enclose the vehicle cabin 18, or selectively retracted into the main body 52 to provide ventilation or enable cargo to pass into the vehicle cabin 18. When folding to the stowed position 58, the window 54 is retracted into the main body 52 to protect the glass. Once folded, large/long cargo may be passed from the storage bed 16 into the vehicle cabin 18, as described herein in more detail.

With continued reference to FIGS. 1 and 2, in the example embodiment, a front wall or firewall 60 is located between and separates the vehicle cabin 18 and the frunk 20. The frunk 20 is a front storage area accessible, for example, via a hood 62 of the vehicle 10. Additionally, the firewall 60 includes a passage 64, which is selectively closed by a powered retractable door 66. In this way, the retractable door 66 maybe opened to allow long cargo to pass between the vehicle cabin 18 and the frunk 20.

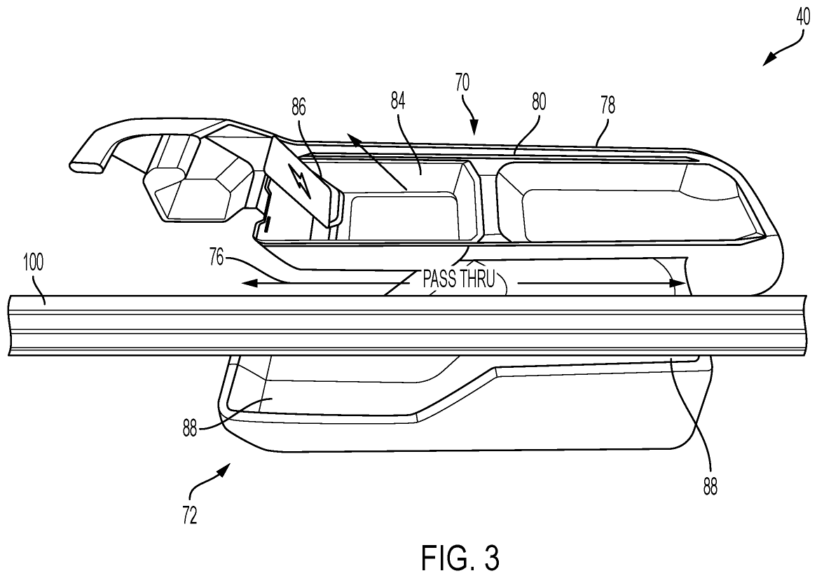

With reference now to FIGS. 2-3, the center console 40 will be described in more detail. In the example embodiment, the center console 40 generally includes an upper storage portion 70 and a lower storage portion 72. The upper storage portion 70 is raised from the lower storage portion 72 via spaced supports 74 to define a passage or pass-through 76 therebetween, as shown in FIG. 3. This enables cargo 100 (e.g., lumber) to pass therethrough without having to remove the center console 40. As shown, in the example embodiment, the firewall passage 64 is generally centered cross-car and aligned with the center console pass-through 76 such that the cargo 100 extends in a fore-aft or substantially fore-aft direction.

In the example embodiment, the upper storage portion 70 includes a frame 78 with a track 80 configured to slidingly support a pair of sliding armrests 82 and cup holders (not shown) in a fore-aft direction. The frame 78 also supports one or more expandable storage compartments or trays 84 (see FIG. 3), which may include one or more integrated wireless (e.g., inductive) chargers 86. When the cargo pass-through 76 is being utilized, the storage tray(s) 84 are moved to a raised position, as shown in FIG. 3, so as to not obstruct the cargo pass-through 76. However, when the cargo pass-through 76 is not being utilized, the storage tray(s) 84 maybe lowered toward the lower storage portion 72 to expand the storage volume. The lower storage portion 72 is coupled to the track system 44 and provides one or more surfaces 88 for cargo or storage.

In one example operation of the cargo pass-through system 12, the operation begins with the foldable midgate 28 in the upright position 56 and the firewall retractable door 66 in the closed position. When desired, a user begins to transition the vehicle 10 and cargo pass-through system 12 to receive cargo 100, for example, manually or via a user interface (e.g., touchscreen display) and controller (not shown). Specifically, the user retracts the window 54 into the midgate main body 52, and the midgate 28 is rotated forward into the stowed position 58 flush with the storage bed floor 26. This action may be automated and/or motorized. The center console storage tray(s) 84 are raised, if in the expanded position, to provide clearance for the center console pass-through 76. If required to accommodate the cargo, the firewall door 66 is opened or retracted to expose passage 64 (e.g., automated and/or motorized). The cargo 100 may then be inserted from the storage bed 16 and into the vehicle cabin 18 over the stowed midgate 28. The cargo 100 is then directed through the center console pass-through 76, and through the firewall passage 64 into the frunk 20. The process may also be performed in reverse beginning with the frunk 20.

Described herein are systems and methods for enabling a vehicle to handle long cargo loads without sacrificing the amenities of a center console. A cargo pass-through system includes a foldable midgate, a center console, and a firewall with a retractable door. The midgate is configured to fold flat to allow cargo to pass between the rear cargo area and vehicle cabin. The center console includes a center console pass-through to receive cargo therethrough without having to remove the center console. The firewall door is configured to open to reveal a passage to allow cargo to pass between the frunk and the vehicle cabin. The center console includes expandable storage available when the center console pass-through is not utilized.

It will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A vehicle, comprising:
a body at least partially defining a vehicle cabin; and
a center console disposed within the vehicle cabin and including a center console pass-through configured to enable cargo to extend therethrough for storage of the cargo.

2. The vehicle of claim 1, wherein the center console comprises:
a lower storage portion coupled to a floor of the vehicle; and
an upper storage portion connected to and spaced apart from the lower storage portion to define the center console pass-through between the lower storage portion and the upper storage portion.

3. The vehicle of claim 2, wherein the vehicle further comprises:
a track system integrated into the vehicle floor, wherein the lower storage portion is removably and slidably coupled to the track system.

4. The vehicle of claim 2, wherein the upper storage portion includes at least one expandable storage tray configured to move between:
a retracted position that does not obstruct the center console pass-through when cargo extends through the center console pass-through; and
an extended position that increases a storage capacity of the expandable storage tray when the center console pass-through is not being utilized.

5. The vehicle of claim 4, wherein the upper storage portion further includes:
a pair of slidable armrests;
one or more slidable cup holders; and
an integrated wireless charger.

6. The vehicle of claim 1, further comprising:
a rear cargo area; and
a foldable midgate separating the rear cargo area and the vehicle cabin,
wherein the foldable midgate is configured to fold substantially flat to enable cargo to extend from the rear cargo area, into the vehicle cabin, and through the center console pass-through.

7. The vehicle of claim 6, wherein the foldable midgate includes a retractable window configured to be selectively retracted into a main body of the foldable midgate for protection thereof.

8. The vehicle of claim 6, wherein the foldable midgate is configured to rotate forward into the vehicle cabin to a stowed position that is substantially planar with a floor of the rear cargo area.

9. The vehicle of claim 6, wherein the rear cargo area is a pickup truck storage bed having a floor, a pair of side walls, and a tailgate.

10. The vehicle of claim 1, further comprising:
a frunk;
a firewall separating the frunk and the vehicle cabin;
a passage extending through the firewall; and
a door configured to move between a closed position that blocks the passage, and an open position that enables cargo to pass through the passage.

11. The vehicle of claim 10, wherein the door is retractable within the firewall.

12. The vehicle of claim 10, further comprising:
a rear cargo area; and
a foldable midgate separating the rear cargo area and the vehicle cabin,
wherein the foldable midgate is configured to fold substantially flat to enable cargo to extend from the rear cargo area, into the vehicle cabin, through the center console pass-through, through the firewall passage, and into the frunk.

13. The vehicle of claim 12, wherein the cargo passes through the center console pass-through at a distance elevated from a floor of the vehicle cabin.

14. The vehicle of claim 13, wherein a floor of the rear cargo area is at a higher elevation than the floor of the vehicle cabin.

15. The vehicle of claim 12, wherein the center console interrupts a path along a floor of the vehicle cabin between the rear cargo area and the firewall passage.

16. The vehicle of claim 1, wherein the vehicle is a battery electric vehicle.
